(19) United States
(12) Patent Application Publication
(10) Pub. No.: US 2026/0277714 A1
(43) Pub. Date: Sep. 17, 2026

(54) SYSTEM FOR INFORMATION EXCHANGE

(71) Applicant: Logistics and Supply Chain MultiTech R&D Centre Limited, Pok Fu Lam (HK)

(72) Inventors: Yi Jun He, Pok Fu Lam (HK); Calvin Chow, Pok Fu Lam (HK); Chiu Lok Tang, Pok Fu Lam (HK); Tsz Ho Pun, Pok Fu Lam (HK); Chun Fai Chan, Pok Fu Lam (HK); Chung Dak Shum, Pok Fu Lam (HK)

(21) Appl. No.: 19/079,612

(22) Filed: Mar. 14, 2025

(51) Int. Cl. G06F 9/54; G06Q 10/083

(52) U.S. Cl. CPC G06F 9/547; G06Q 10/083

(57) ABSTRACT

A system for information exchange includes a relay chain, the relay chain including: a gateway arranged to communicate with a first interface to process a first exchange data from the first interface and to communicate with a second interface to process a second exchange data associated with the first exchange data, wherein the second interface is arranged to undergo an update associated with the first exchange data and the first interface is arranged to undergo an update associated with the second exchange data; a first validator arranged to verify the successful data exchange on the second interface associated with the first exchange data; and a second validator arranged to verify the successful data exchange on the first interface associated with the second exchange data.

### TECHNICAL FIELD

The invention relates to a system for information exchange, and particularly, although not exclusively, to a system for pharmaceutical supply chain information exchange between two cross-broader platforms.

### BACKGROUND

In November 2019, Hong Kong Chief Executive Carrie Lam announced 16 measures benefiting Hong Kong people after attending the meeting of the Leading Group for the Development of the Guangdong-Hong Kong-Macao Greater Bay Area.

One important measure includes allowing the use of Hong Kong-registered pharmaceuticals and common medical devices in designated Hong Kong-owned healthcare institutions in the Greater Bay Area.

As a ballpark figure, there are currently 56 urgently needed imported drugs and medical devices and the circulation would involves 19 designated medical institutions in Guangdong-Hong Kong-Macao Greater Bay Area.

### SUMMARY OF THE INVENTION

In accordance with a first aspect of the present invention, there is provided a system for information exchange comprising a relay chain, the relay chain comprising:
a gateway arranged to communicate with a first interface to process a first exchange data from the first interface and to communicate with a second interface to process a second exchange data associated with the first exchange data, wherein the second interface is arranged to undergo an update associated with the first exchange data and the first interface is arranged to undergo an update associated with the second exchange data;
a first validator arranged to verify the successful data exchange on the second interface associated with the first exchange data; and
a second validator arranged to verify the successful data exchange on the first interface associated with the second exchange data.

In accordance with the first aspect, the relay chain is arranged to store data exchange record independently from the first and second interfaces.

In accordance with the first aspect, the relay chain comprises a smart contract arranged to determine the access to the relay chain via management of encryption key.

In accordance with the first aspect, the relay chain comprises a cross chain data exchange node server.

In accordance with the first aspect, the relay chain comprises multiple nodes arranged to execute the smart contract.

In accordance with the first aspect, the relay chain comprises one or more nodes associated with the first interface for communicating the first exchange data with the first interface.

In accordance with the first aspect, the relay chain comprises one or more nodes associated with the second interface for communicating the second exchange data with the second interface.

In accordance with the first aspect, the node of the relay chain is arranged to receive the first exchange data from the first interface and sign the first exchange data if the condition of the smart contract is fulfilled and send the signed first exchange data to the first interface.

In accordance with the first aspect, the first validator is arranged to receive a status validation from the first interface for verifying whether the second exchange data is successfully uploaded to the second interface.

In accordance with the first aspect, the smart contract is arranged to update the relay chain upon the successful validation of the second interface.

In accordance with the first aspect, the node of the relay chain is arranged to receive the second exchange data from the relay chain and sign the second exchange data if the condition of the smart contract is fulfilled and send the signed second exchange data to the second interface.

In accordance with the first aspect, the second validator is arranged to receive a status validation from the second interface for verifying whether the first exchange data is successfully uploaded to the first interface.

In accordance with the first aspect, the smart contract is arranged to update the relay chain upon the successful validation of the first interface.

In accordance with the first aspect, the data exchange includes an exchange of pharmaceutical logistics information.

In accordance with the first aspect, the first exchange data generated by the first interface is associated with a purchase, delivery and logistics activity.

In accordance with the first aspect, the second exchange data generated by the second interface is associated with the approval issuance information associated with the purchase, delivery and logistics activity of the first interface.

In accordance with the first aspect, the first interface further comprises an application arranged to communicate the first exchange data between the blockchain of the first interface and the relay chain.

In accordance with the first aspect, the second interface further comprises an application arranged to communicate the second exchange data between the blockchain of the second interface and the relay chain.

In accordance with the first aspect, the blockchain of the first interface further comprises a channel with multiple nodes and the blockchain of the first interface is arranged to broadcast the first exchange data to the nodes.

In accordance with the first aspect, the blockchain of the second interface further comprises multiple nodes and the blockchain of the second interface is arranged to broadcast the second exchange data to the nodes.

### BRIEF DESCRIPTION OF THE DRAWINGS

Embodiments of the present invention will now be described, by way of example, with reference to the accompanying drawings in which:

FIG. 1 is a schematic diagram showing a GD-HK pharmaceutical logistics information exchange channel using blockchain technology in accordance with an embodiment of the present invention.

FIG. 2 is a flowchart showing a mechanism in accordance with an embodiment of the present invention.

FIG. 3 is a schematic diagram showing the structure of the cross-chain data exchange channel in accordance with an embodiment of the present invention.

FIG. 4 is a schematic diagram showing a cross-chain data integrity protection protocol in accordance with an embodiment of the present invention.

### DETAILED DESCRIPTION OF THE PREFERRED EMBODIMENTS

Without wishing to be bound by theory, the inventors have discovered that some critical issues have to be resolved before extending the use of HK registered drugs and medical devices in HK public hospitals to the designated medical institutions in Guangdong-Hong Kong-Macao Greater Bay Area. For instance, these issues may arise in the pharmaceutical circulation, such as standard compatibility, privacy protection, cross-boundary data sharing, and data coordination.

In one example embodiment, the present invention suggests a data exchange platform which includes an innovative GD-HK pharmaceutical logistics information exchange channel using blockchain technology. Such a GD-HK cross chain information exchange channel may facilitate cross-broader exchange of information, in particular pharmaceutical supply chain information, where the regulatory department in HK uses a blockchain called Hyperledger Fabric and Repchain is used in GD.

Preferably, the data exchange platform has the following key functions:
1. Keeping data exchange record in a separate blockchain.
2. Validating successful exchange of cross-chain data to other party's blockchain.
3. Ensuring data accuracy and consistency on both parties' blockchain.
4. Authentication and Access Control.
5. Data Access Management Based on Smart Contracts.

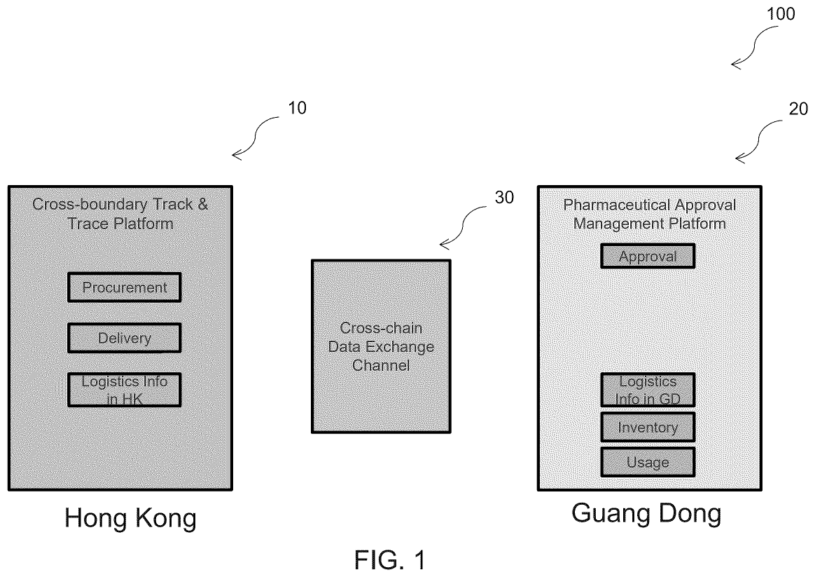

Referring to FIGS. 1 to 4, there is shown an embodiment of a system for information exchange comprising a relay chain 330, the relay chain 330 comprising: a gateway 340 arranged to communicate with a first interface 310 to process a first exchange data from the first interface 310 and to communicate with a second interface 320 to process a second exchange data associated with the first exchange data, wherein the second interface 320 is arranged to undergo an update associated with the first exchange data and the first interface 310 is arranged to undergo an update associated with the second exchange data; a first validator 336 arranged to verify the successful data exchange on the second interface 320 associated with the first exchange data; and a second validator 338 arranged to verify the successful data exchange on the first interface 310 associated with the second exchange data.

With Reference to FIG. 1, There Is Shown an Architecture of a Data exchange platform 100 designed for supporting business collaboration between two different chains and multiple organizations. The data exchange platform 100 here may be embodied as a cross-boundary pharmaceutical circulation & regulation platform 100 which supports the collaboration between a Cross-boundary Track & Trace Platform 10 for Pharmaceutical Supply Chain and a Pharmaceutical Approval Management Platform 20.

The Cross-boundary Track & Trace Platform 10 stores the procurement, delivery and logistics info in HK. On the other hand, the Pharmaceutical Approval Management Platform 20 stores the logistics info in GD, inventory and usage. The Cross-boundary Track & Trace Platform 10 also regularly registers the imported drugs and medical devices and is responsible for cross-boundary data upload. On the other hand, the Pharmaceutical Approval Management Platform 20 is responsible for approving the procurement and the usage of these imported drugs and medical devices in the designated medical institutions in Guangdong-Hong Kong-Macao Greater Bay Area.

The Cross-boundary Track & Trace Platform 10 is based on Consortium Blockchain and the Pharmaceutical Approval Management Platform 20 is based on Domestic Blockchain respectively. Each of the blockchains in these platforms 10, 20 involves a separate smart contract with a self-executing agreement with the terms of the agreement directly written into code. These contracts run on blockchain networks and automatically enforce rules and permissions for data access without the need for intermediaries. With predefined rules implemented, smart contracts are programmed with specific terms and conditions. Once these conditions are met, the contract automatically executes actions to trigger the events, such as new data uploading, as desired.

Whenever there is a new procurement of imported drugs and medical devices in HK, the procurement also has to be approved by Guang Dong as a standard procurement procedure of the designated medical institutions in Guangdong-Hong Kong-Macao Greater Bay Area. However, as different organizations use different blockchains, e.g., Consortium chains and private chains, this prevents effective interconnection between blockchains.

To address this issue, the cross-boundary pharmaceutical circulation & regulation platform 100 further includes a Cross-chain Data Exchange Channel 30 for the data exchange between the Cross-boundary Track & Trace Platform 10 and the Pharmaceutical Approval Management Platform 20.

This Cross-chain Data Exchange Channel 30 may adopt Guangdong-Hong Kong data cross-chain channel technology, which is an important technology for data transfer and value transfer between blockchains. After the exchange channel built, purchase, delivery and logistics information of Hong Kong enterprises are exchanged to GD platform 20, and approval issuance information generated in Guangdong is exchanged to HK platform 10. The exchanged data is merged in GD, and formed a complete track and trace chain. This technology achieves traceability of all pharmaceuticals of procurement, delivery and usage and meets the data monitoring requirement of regulatory department.

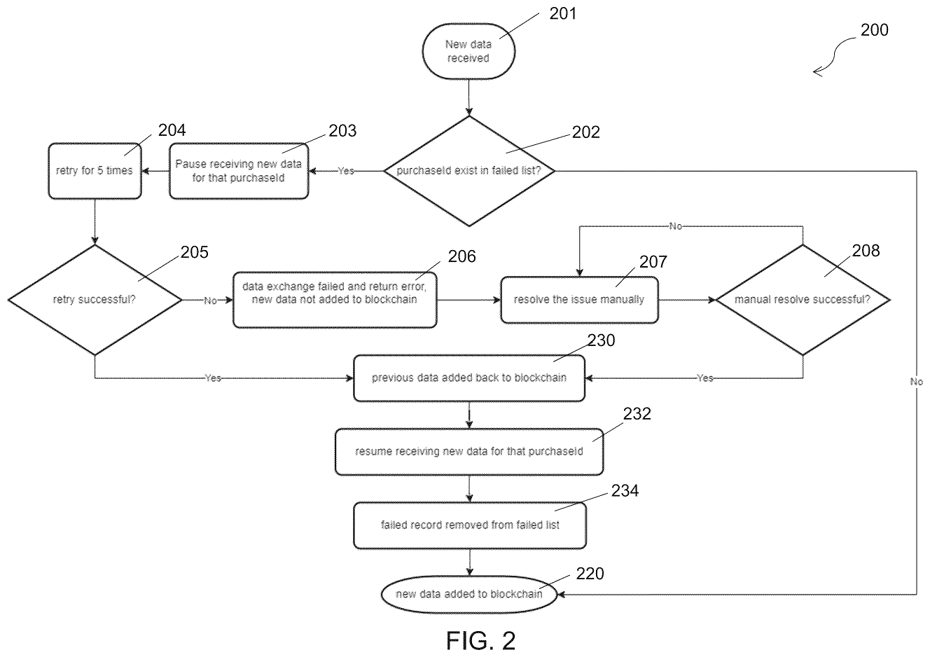

With reference to FIG. 2, there is shown a flowchart illustrating an algorithm 200 of the data exchange platform 100 in accordance with one example embodiment of the present invention.

The algorithm 200 begins with step 201 of receiving new data from the Cross-boundary Track & Trace Platform 10 and proceed to step 202 of checking if the purchase ID exists in the failed list. At step 202, the algorithm 200 would verify whether the purchase ID in the new data received exists in a failed list which stores a record of transactions or data entries that were not successfully processed or validated by the network. Failed transactions may be caused by various reasons such as a smart contract error in which an error in the contract's code is found in a smart contract transaction, the transaction can fail. Other reason could be like network congestions. If the purchase ID exists in the failed list, the algorithm 200 would pause receiving new data for that purchased ID (step 203).

Before adding the new data to the blockchain using smart contract, these data should be validated and the algorithm 200 would retry the validation for a several times (step 204). For instance, the algorithm 200 may adopt a relay chain with one or more validators for validating whether the data exchange from the Cross-boundary Track & Trace Platform 10 has been successfully dispatched to the Pharmaceutical Approval Management Platform 20. If the purchase ID does not exist in the failed list, the algorithm 200 would add the new data to the blockchain (step 220).

After retrying for several times, the algorithm 200 would verify whether the retry was successful (at step 205). If the retry was successful, previous data would be added back to the blockchain (step 230). The algorithm 200 would then resume the receiving of new data for that purchase ID (step 232) and the failed record would be removed form the failed list (step 234). Finally, the new data would be added to blockchain (step 220).

In contrast, if the data exchange failed and return error, the new data would not be added to the blockchain (step 206). The administrator of the algorithm 200 would try to resolve the issue manually (step 207). The algorithm 200 would then verify if the manual resolved is successful (step 208). If the issue is not manually resolved, the administrator of the algorithm 200 would be alerted again and steps 207 to 208 would be repeated.

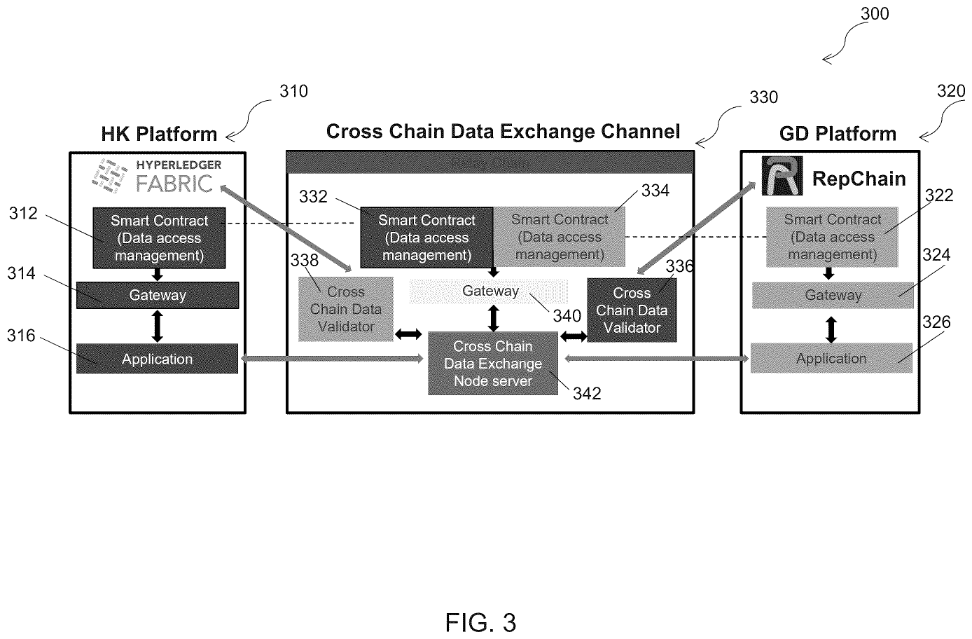

With reference to FIG. 3, there is shown a schematic illustrating an architecture 300 of the data exchange platform 100 in accordance with one example embodiment of the present invention.

The HK Platform may include a blockchain network 310 created by a codebase e.g., Hyperledger Fabric and a smart contract 312 for data access management. The HK Platform may include a gateway 314 serving as a network node that connects networks with different transmission protocols together. The HK Platform may also include a client application 316 which can establish a connection to the gateway 314 that will be used to transact with the blockchain network 310.

Similarly, the GD Platform may include a blockchain network 320 created by another codebase e.g., RepChain and a smart contract 322 for data access management. The HK Platform may include a gateway 324 serving as a network node that connects networks with different transmission protocols together. The GD Platform also includes a client application 326 which can establish a connection to the gateway 326 that will be used to transact with the blockchain network 320.

As HK platform and GD platform use different blockchains and have their own smart contract (data access management), there is a need of a cross-chain data exchange channel for the information sharing across the two different platforms.

In one example embodiment, the cross-chain data exchange channel may comprise a plurality of major components. In particular, the cross-chain data exchange channel may include a relay chain 330 which is a separate blockchain from the blockchain networks 310, 320 and keeps data exchange records, manage transactions ordering and consensus. The relay chain 330 also includes a first smart contract 332 and a second smart contract 334.

Importantly, the cross-chain data exchange channel also includes one or more cross-chain data validators for verifying if cross-chain data is successfully exchanged and exists on the other party's blockchain actually. The validation here is a cross relationship, i.e., successfully uploading a new transaction in the GD blockchain is validated by the cross-chain data validator owned by HK, and vice versa.

In one example embodiment, the relay chain 330 may include a first cross chain data validator 336 for verifying if cross-chain data is successfully exchanged and exists on the blockchain network 320 of the GD Platform. The relay chain 330 may also include a second cross chain data validator 338 for verifying if cross-chain data is successfully exchanged and exists on the blockchain network 310 of the HK Platform.

The cross-chain data exchange channel may include a gateway 340 serving as a network node that connects networks with different transmission protocols together. The cross-chain data exchange channel may also include a cross-chain data exchange node server 342 for connecting to the client application 316 of the HK platform, the client application 326 of the GD platform and the components of the relay chain 330 such as the first cross chain data validator 336, the second cross chain data validator 338 and the cross-chain data exchange node server 342.

The cross-chain data exchange channel may also include a cross-chain data integrity protection protocol. For instance, such a protocol to assure data accuracy and consistency on HK and GD blockchain. The cross-chain data exchange channel may also include an authentication and access control: For instance, the control may verify blockchain user identity and the authentication token, in order to control access right to blockchain and the system.

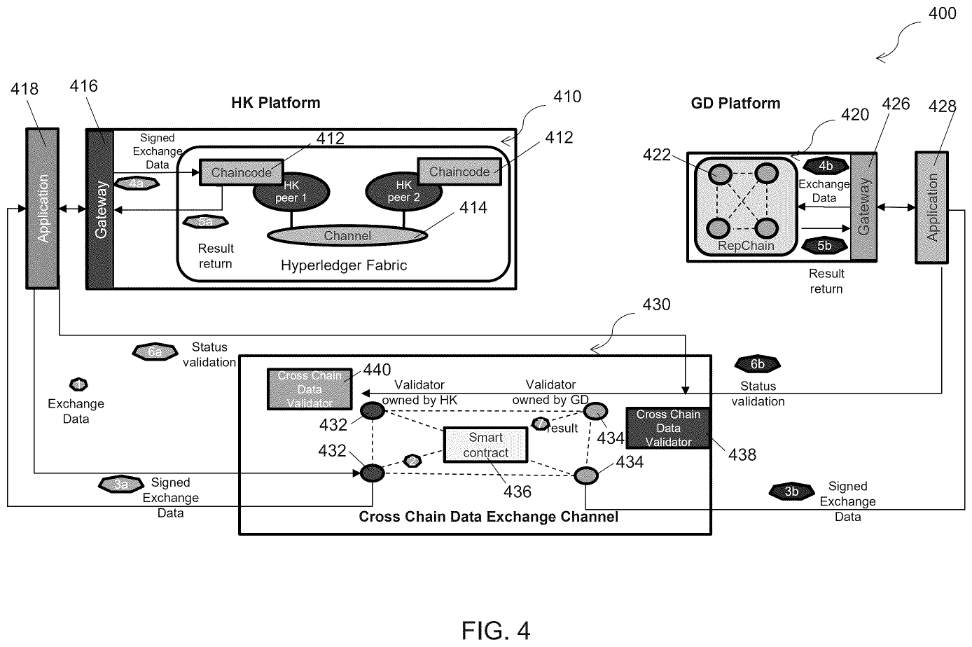

With reference finally to FIG. 4, there is shown a schematic illustrating an architecture 400 of the cross-chain data integrity protection protocol in accordance with one example embodiment of the present invention. The protocol is provided for facilitating the data exchange between the HK Platform and the GD Platform.

The HK Platform may include a blockchain network 410 created by a codebase e.g., Hyperledger Fabric and a smart contract/chaincode 412 for data access management which can be invoked by one or more peers e.g., HK peer 1 and HK peer 2 communicating through channel 414. The HK Platform may include a gateway 416 serving as a network node that connects networks with different transmission protocols together. The HK Platform may also include a client application 418 which can establish a connection to the gateway 416 that will be used to transact with the blockchain network 410.

Similarly, the Gd Platform may include a blockchain network 420 created by another codebase e.g., RepChain and a smart contract/chaincode (not shown) for data access management which can be invoked by one or more peers 422. The GD Platform may include a gateway 426 serving as a network node that connects networks with different transmission protocols together. The GD Platform may also include a client application 428 which can establish a connection to the gateway 426 that will be used to transact with the blockchain network 420.

In one example embodiment, the cross-chain data exchange channel may comprise a plurality of major components. In particular, the cross-chain data exchange channel may include a relay chain 430 which is a separate blockchain from the blockchain networks 410, 420 and keeps data exchange records, manage transactions ordering and consensus.

Preferably, the relay chain 430 is a blockchain network formed by peers from multiple organizations. For instance, the relay chain 430 is formed by one or more peers 432 corresponding to the HK peer 1 and HK peer 2 of the HK platform and one or more peers 434 corresponding to the peers 422 of the GD Platform. The relay chain 430 also includes a smart contract/chaincode 436 which is installed and instantiated on each of these peers 432, 434 within the relay chain 430. The relay chain 430 may also include a first cross chain data validator 440 for verifying if cross-chain data is successfully exchanged and exists on the blockchain network 420 of the GD Platform. The relay chain 430 may also include a second cross chain data validator 438 for verifying if cross-chain data is successfully exchanged and exists on the blockchain network 410 of the HK Platform.

The Cross Chain Data Exchange Channel allows specific set of peers and applications to communicate with each other within the relay chain network. Through the peer connection between the application 418 of the HK platform, the application 428 of the GD platform and the peers 432, 434 within the relay chain 430, applications 418, 428 can query or update a ledger. For instance, the application 418 of the HK platform can communicate directly with the node 432 through the Cross Chain Data Exchange Channel. Application 428 of the GD platform can communicate directly with the node 434 through the Cross Chain Data Exchange Channel.

To kick start, application 418 generates a transaction proposal in an exchange data which it sends to one or more peers 432 within the relay chain 430 for endorsement (step 1). The transaction proposal can be independently executed by peer 432 who returns endorsed proposal response. The smart contract 436 is then invoked on the endorsing peer 432 of the HK Platform who simulates the execution of the smart contract 436 against its copy of the ledger within the relay chain 430 (step 2). Here, the endorsing peer 432 then executes the chaincode 436 using the transaction proposal to generate a transaction proposal response. The peer 432 may endorse the proposal response by adding its digital signature, and signing the entire payload using its private key. The peer 432 may then send the proposal response (endorsement) i.e., signed exchange data back to the application 418 of the HK Platform (step 3a).

Meanwhile, the smart contract 436 is also invoked on one or more peers 434 of the GD Platform who simulates the execution of the smart contract 436 against their copy of the ledger (not shown) and send the proposal response (endorsement) i.e., signed exchange data to the application 428 of the GD Platform (step 3b). The peer 434 may endorse the proposal response by adding its digital signature, and signing the entire payload using its private key. The peer 434 may then send the proposal response (endorsement) i.e., signed exchange data back to the application 428 of the GD Platform (step 3b).

The gateway 416 of the HK platform subsequently receives the signed exchange data from the application 418 and sends the signed exchange data to the blockchain network 410 (step 4a). The blockchain network 410 then distributes the signed exchange data to both HK peer 1 and HK peer 2 within the blockchain network 410 of the HK Platform. Each of the HK peer 1 and HK peer 2 may execute a chaincode 412 using the signed exchanged data and generate a response endorsing the signed exchange data. In particular, the HK peer 1 and the HK peer 2 may process the signed exchange data receiving from the gateway 416 and result in a new block being added to ledger on the HK peer 1 and the HK peer 2 respectively. Once the process is complete, the ledger has been consistently updated on both HK peer 1 and HK peer 2, and the result (endorsed response) returns to the gateway 416 and subsequently inform the application 418 that the transaction has been processed (step 5a).

Meanwhile, the gateway 426 of the GD platform also receives the signed exchange data from the application 428 and sends the signed exchange data to the blockchain network 420 (step 4b). The blockchain network 420 then distributes the signed exchange data to the peers 422 within the blockchain network 420 of the GD Platform. Each of the peers 422 execute a chaincode using the signed exchanged data and generate a response endorsing the signed exchange data. Similarly, the peers 422 may process the signed exchange data receiving from the gateway 426 and result in a new block being added to ledger on the peers 422. Once the process is complete, the ledger has been consistently updated on the peers 422, and the result (endorsed response) returns to the gateway 426 and subsequently inform the application 428 that the transaction has been processed (step 5b).

Next, the application 418 of the HK Platform may generate a status validation which it sends to the cross-chain data validator 438 for validation (step 6a). The cross-chain data validator 438 will verify whether the signed exchange data has been sent to the peers 422 within the Repchain 420 and endorsed by the peers 422 within the Repchain 420 in step 4b. If the cross-chain data validator 438 determines that the transaction has been endorsed by the peers 422 in step 4b, the data exchange is considered valid and the peer 434 would pass the successful validation result to update the relay chain 430 using the smart contract 436 (step 7). This process of validation verifies that purchase, delivery and logistics information of Hong Kong enterprises are exchanged to the blockchain network 420 of the GD platform.

Meanwhile, the application 428 of the GD Platform also generates a status validation which it sends to the cross-chain data validator 440 for validation (step 6b). The cross-chain data validator 440 will verify whether the signed exchange data has been sent to the HK peer 1 and HK peer 2 within the blockchain 410 and endorsed by the HK peer 1 and HK peer 2 within the blockchain 410 in step 4a. If the cross-chain data validator 440 determines that the transaction has been endorsed by the HK peer 1 and HK peer 2 in step 4a, the data exchange is considered valid and the peer 432 would pass the successful validation result to update the relay chain 430 using the smart contract 436 (not shown). This process of validation verifies that approval issuance information generated in Guangdong is exchanged to HK platform.

Advantageously, the present invention may provide a one-stop cross-boundary pharmaceutical circulation & regulation platform facilitating HK/GBA pharma distributors, hospitals in GBA, as well as regulatory authorities in both Mainland China and Hong Kong. This involves 19 designated medical institutions and 56 urgently needed imported drugs and medical devices. Such registration is benefiting more than 4000 people.

Advantageously, the one-stop cross-boundary pharmaceutical circulation & regulation platform of the present invention realizes successful information exchange between different blockchains, thus the platform realizes 100% successful information uploading and exchange. The present invention may establish a secure and efficient channel for data exchange and achieve standard compatibility, trackability and traceability.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for information exchange comprising a relay chain, the relay chain comprising:
a gateway arranged to communicate with a first interface to process a first exchange data from the first interface and to communicate with a second interface to process a second exchange data associated with the first exchange data, wherein the second interface is arranged to undergo an update associated with the first exchange data and the first interface is arranged to undergo an update associated with the second exchange data;
a first validator arranged to verify the successful data exchange on the second interface associated with the first exchange data; and
a second validator arranged to verify the successful data exchange on the first interface associated with the second exchange data.

2. A system for information exchange in accordance with claim 1, wherein the relay chain is arranged to store data exchange record independently from the first and second interfaces.

3. A system for information exchange in accordance with claim 2, wherein the relay chain comprises a smart contract arranged to determine the access to the relay chain via management of encryption key.

4. A system for information exchange in accordance with claim 3, wherein the relay chain comprises a cross chain data exchange node server.

5. A system for information exchange in accordance with claim 4, wherein the relay chain comprises multiple nodes arranged to execute the smart contract.

6. A system for information exchange in accordance with claim 5, wherein the relay chain comprises one or more nodes associated with the first interface for communicating the first exchange data with the first interface.

7. A system for information exchange in accordance with claim 6, wherein the relay chain comprises one or more nodes associated with the second interface for communicating the second exchange data with the second interface.

8. A system for information exchange in accordance with claim 6, wherein the node of the relay chain is arranged to receive the first exchange data from the first interface and sign the first exchange data if the condition of the smart contract is fulfilled and send the signed first exchange data to the first interface.

9. A system for information exchange in accordance with claim 8, wherein the first validator is arranged to receive a status validation from the first interface for verifying whether the second exchange data is successfully uploaded to the second interface.

10. A system for information exchange in accordance with claim 9, wherein the smart contract is arranged to update the relay chain upon the successful validation of the second interface.

11. A system for information exchange in accordance with claim 7, wherein the node of the relay chain is arranged to receive the second exchange data from the relay chain and sign the second exchange data if the condition of the smart contract is fulfilled and send the signed second exchange data to the second interface.

12. A system for information exchange in accordance with claim 11, wherein the second validator is arranged to receive a status validation from the second interface for verifying whether the first exchange data is successfully uploaded to the first interface.

13. A system for information exchange in accordance with claim 12, wherein the smart contract is arranged to update the relay chain upon the successful validation of the first interface.

14. A system for information exchange in accordance with claim 1, wherein the data exchange includes an exchange of pharmaceutical logistics information.

15. A system for information exchange in accordance with claim 14, wherein the first exchange data generated by the first interface is associated with a purchase, delivery and logistics activity.

16. A system for information exchange in accordance with claim 15, wherein the second exchange data generated by the second interface is associated with the approval issuance information associated with the purchase, delivery and logistics activity of the first interface.

17. A system for information exchange in accordance with claim 1, wherein the first interface further comprises an application arranged to communicate the first exchange data between the blockchain of the first interface and the relay chain.

18. A system for information exchange in accordance with claim 1, wherein the second interface further comprises an application arranged to communicate the second exchange data between the blockchain of the second interface and the relay chain.

19. A system for information exchange in accordance with claim 17, wherein the blockchain of the first interface further comprises a channel with multiple nodes and the blockchain of the first interface is arranged to broadcast the first exchange data to the nodes.

20. A system for information exchange in accordance with claim 18, wherein the blockchain of the second interface further comprises multiple nodes and the blockchain of the second interface is arranged to broadcast the second exchange data to the nodes.
